(19) United States
(12) Patent Application Publication
(10) Pub. No.: US 2026/0044783 A1
(43) Pub. Date: Feb. 12, 2026

(54) TASK EXECUTION METHOD, TRAINING METHOD, ELECTRONIC DEVICE, AND STORAGE MEDIUM

(71) Applicant: Beijing Baidu Netcom Science Technology Co., Ltd., Beijing (CN)

(72) Inventors: Junyuan SHANG, Beijing (CN); Yilong CHEN, Beijing (CN); Zhenyu ZHANG, Beijing (CN); Yinqi YANG, Beijing (CN); Shuohuan WANG, Beijing (CN); Yu SUN, Beijing (CN)

(21) Appl. No.: 19/365,121

(22) Filed: Oct. 21, 2025

(30) Foreign Application Priority Data
May 30, 2025 (CN) 202510725374.8

(51) Int. Cl. G06N 20/00; G06F 9/50

(52) U.S. Cl. CPC G06N 20/00; G06F 9/5027

(57) ABSTRACT

The task execution method includes: retrieving, from a storage unit, a hyperparameter of a target network layer in a target model; executing, using an operator unit, a first computational subtask in a computational task, according to the hyperparameter of the target network layer, so as to obtain a first feature output by the target network layer; executing, in response to reusing the hyperparameter of the target network layer, a second computational subtask in the computational task using the operator unit based on the first feature retrieved from the storage unit, so as to obtain a second feature output by the target network layer, where the first computational subtask and the second computational subtask are subtasks sequentially executed in the computational task; and determining a model output result of the target model using the operator unit based on the second feature retrieved from the storage unit.

This application claims the benefit of priority to Chinese Patent Application No. 202510725374.8, filed on May 30, 2025. The entire contents of this application are hereby incorporated herein by reference.

### TECHNICAL FIELD

The present disclosure relates to a field of artificial intelligence technology, and in particular to fields of deep learning technology and large model technology. More specifically, the present disclosure provides a task execution method, a training method, an electronic device, and a storage medium.

### BACKGROUND

With a rapid development of artificial intelligence technology, various types of data such as text, an image, an audio, etc. may be processed based on a large model, so as to satisfy actual requirements of various scenarios through an output result of the large model.

### SUMMARY

The present disclosure provides a task execution method, a training method, an electronic device, and a storage medium.

According to an aspect of the present disclosure, a task execution method is provided, including: retrieving, from a storage unit, a hyperparameter of a target network layer in a target model; executing, using an operator unit, a first computational subtask in a computational task according to the hyperparameter of the target network layer, so as to obtain a first feature output by the target network layer; executing, in response to reusing the hyperparameter of the target network layer, a second computational subtask in the computational task using the operator unit based on the first feature retrieved from the storage unit, so as to obtain a second feature output by the target network layer, where the first computational subtask and the second computational subtask are subtasks sequentially executed in the computational task; and determining a model output result of the target model using the operator unit based on the second feature retrieved from the storage unit.

According to another aspect of the present disclosure, a model training method is provided, including: retrieving, from a storage unit, a hyperparameter of an initial network layer in an initial model; executing, using an operator unit, a first computational subtask in a computational task according to the hyperparameter of the initial network layer, so as to obtain a first initial feature output by the initial network layer; executing, in response to reusing the hyperparameter of the initial network layer, a second computational subtask in the computational task using the operator unit based on the first initial feature retrieved from the storage unit, so as to obtain a second initial feature output by the initial network layer, where the first computational subtask and the second computational subtask are subtasks sequentially executed in the computational task; determining a model output result of the initial model using the operator unit based on the second initial feature retrieved from the storage unit; determining target loss information using the operator unit according to the model output result of the initial model; and training the initial model using the operator unit according to the target loss information, so as to obtain a trained target model.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the task execution method or the model training method.

According to another aspect of the present disclosure, a non-transitory computer-readable storage medium having computer instructions stored therein is provided, where the computer instructions are configured to cause a computer to implement the task execution method or the model training method.

It should be understood that the content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 schematically shows an exemplary system architecture to which a task execution method and a task execution apparatus may be applied according to embodiments of the present disclosure;

FIG. 2 schematically shows a flowchart of a task execution method according to embodiments of the present disclosure;

FIG. 3 schematically shows a schematic diagram of a target model according to embodiments of the present disclosure;

FIG. 4 schematically shows a schematic diagram of determining a target model according to embodiments of the present disclosure;

FIG. 5 schematically shows a flowchart of a model training method according to embodiments of the present disclosure;

FIG. 6 schematically shows a schematic diagram of a model training method according to embodiments of the present disclosure;

FIG. 7 schematically shows a block diagram of a task execution apparatus according to embodiments of the present disclosure;

FIG. 8 schematically shows a block diagram of a model training apparatus according to embodiments of the present disclosure; and

FIG. 9 shows a schematic block diagram of an exemplary electronic device for implementing a task execution method or a model training method according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those skilled in the art should realize that various changes and modifications may be made to embodiments described herein without departing from the scope and spirit of the present disclosure. Likewise, for clarity and conciseness, descriptions of well-known functions and structures are omitted in the following description.

In the technical solution of the present disclosure, an acquisition, a storage, an application, etc. of user personal information involved comply with provisions of relevant laws and regulations, use necessary confidentiality measures, and do not violate public order and good custom.

In a field of deep learning, the large model is widely used in various application scenarios such as intelligent search, intelligent customer service, intelligent document editing, intelligent device control, etc. However, the applications of the large model in these scenarios often incur a high inference cost, a harsh training condition, and a great deployment difficulty. The large model may include a large language model (LLM), a large image model, a large audio model, etc.

Embodiments of the present disclosure provide a task execution method, a task execution apparatus, a training method, a training apparatus, an electronic device, and a storage medium. The task execution method includes: retrieving, from a storage unit, a hyperparameter of a target network layer in a target model; executing, using an operator unit, a first computational subtask in a computational task according to the hyperparameter of the target network layer, so as to obtain a first feature output by the target network layer; executing, in response to reusing the hyperparameter of the target network layer, a second computational subtask in the computational task using the operator unit based on the first feature retrieved from the storage unit, so as to obtain a second feature output by the target network layer, where the first computational subtask and the second computational subtask are subtasks sequentially executed in the computational task; and determining a model output result of the target model using the operator unit based on the second feature retrieved from the storage unit.

According to embodiments of the present disclosure, the first computational subtask in the computational task is executed using the operator unit according to the hyperparameter of the target network layer retrieved from the storage unit, so as to obtain the first feature output by the target network layer, and in response to reusing the hyperparameter of the target network layer, the second computational subtask executed sequentially in the computational task is executed using the operator unit according to the first feature. In this way, the operator unit may execute the computational task by reusing the hyperparameter of the target network layer stored in the storage unit, so that the operator unit may execute a plurality of subtasks in the computational task by cyclically reusing the hyperparameter of the target network layer retrieved from the storage unit, which simulates a data deep processing process of a plurality of network layers by reusing the hyperparameter of the target network layer to sequentially execute the plurality of subtasks. Furthermore, under a condition that the storage unit stores a small number of hyperparameters, a data deep processing process of a large model with a large parameter scale is achieved, and an accuracy of the model output result of the target model is close to an accuracy of an output result of a large model with a large model parameter scale, thereby reducing a storage space occupation of the storage unit, improving a convenience of deployment of the target model, reducing an inference cost and a deployment cost of the target model, and enhancing a generalization ability of the target model in data processing.

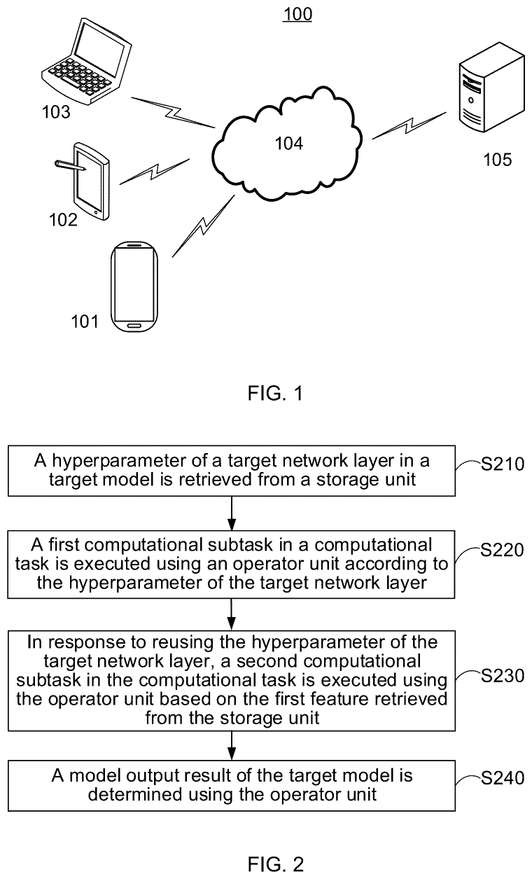

FIG. 1 schematically shows an exemplary system architecture to which a task execution method and a task execution apparatus may be applied according to embodiments of the present disclosure.

It should be noted that FIG. 1 is only an example of a system architecture to which embodiments of the present disclosure may be applied so as to help those skilled in the art understand the technical content of the present disclosure, but it does not mean that embodiments of the present disclosure may not be applied to other devices, systems, environments or scenarios. For example, in other embodiments, an exemplary system architecture to which the task execution method and the task execution apparatus may be applied may include a terminal device. The terminal device may implement the task execution method and the task execution apparatus provided in embodiments of the present disclosure without interacting with a server.

As shown in FIG. 1, a system architecture 100 according to such embodiments may include terminal devices 101, 102, 103, a network 104, and a server 105. The network 104 is a medium used to provide a communication link between the terminal devices 101, 102, 103 and the server 105. The network 104 may include various connection types, such as wired or wireless communication links, etc.

The terminal devices 101, 102, 103 may be used by a user to interact with the server 105 via the network 104, so as to receive or send messages, etc. For example, the terminal device 101 may send a request for text processing to the server 105 through the network 104.

Various communication client applications may be installed on the terminal devices 101, 102, 103, such as knowledge retrieving applications, web browser applications, search applications, instant messaging tools, mailbox clients and/or social platform software, etc. (for example only).

The terminal devices 101, 102, 103 may be various electronic devices having display screens and supporting web browsing, including but not limited to smartphones, tablet computers, laptop computers, desktop computers, etc.

The server 105 may be a server that provides various services, such as a background management server (for example only) that provides a support for a content browsed by the user using the terminal devices 101, 102, 103. The background management server may analyze and process a received user request and other data, and feed back a processing result (e.g., web page, information or data acquired or generated according to the user request) to the terminal devices.

The server 105 may be a cloud server, also known as a cloud computing server or a cloud host, which is a host product in a cloud computing service system to solve shortcomings of difficult management and weak business scalability existing in an existing physical host and VPS (Virtual Private Server) service. The server may also be a server of a distributed system, or a server combined with a block-chain.

It should be noted that the task execution method provided by embodiments of the present disclosure may generally be performed by the server 105. Accordingly, the task execution apparatus provided by embodiments of the present disclosure may also be provided in the server 105. The task execution method provided by embodiments of the present disclosure may also be performed by a server or server cluster different from the server 105 and capable of communicating with the terminal devices 101, 102, 103 and/or the server 105. Accordingly, the task execution apparatus provided by embodiments of the present disclosure may also be provided in a server or server cluster different from the server 105 and capable of communicating with the terminal devices 101, 102, 103 and/or the server 105. For example, the method provided by the present disclosure may be performed using a computing unit of a hardware device in the server 105 or a server node. Based on the task execution method provided by the present disclosure, a multi-head self-attention mechanism may be converted into a group query attention mechanism with lower computing resources and storage resources.

Alternatively, the task execution method provided by embodiments of the present disclosure may also be performed by the terminal device 101, 102, or 103. Accordingly, the task execution apparatus provided by embodiments of the present disclosure may also be provided in the terminal device 101, 102, or 103.

It should be understood that the numbers of terminal devices, networks and servers shown in FIG. 1 are only schematic. According to implementation needs, any number of terminal devices, networks and servers may be provided.

FIG. 2 schematically shows a flowchart of a task execution method according to embodiments of the present disclosure.

As shown in FIG. 2, the method includes operations S210 to S240.

In operation S210, a hyperparameter of a target network layer in a target model is retrieved from a storage unit.

In operation S220, a first computational subtask in a computational task is executed using an operator unit according to the hyperparameter of the target network layer, so as to obtain a first feature output by the target network layer.

In operation S230, in response to reusing the hyperparameter of the target network layer, a second computational subtask in the computational task is executed using the operator unit based on the first feature retrieved from the storage unit, so as to obtain a second feature output by the target network layer.

In operation S240, a model output result of the target model is determined using the operator unit based on the second feature retrieved from the storage unit.

According to embodiments of the present disclosure, the operator unit may be a component in a computing module and used for performing a computational operation. The computing module may include at least one of a Central Processing Unit (CPU), a Graphics Processing Unit (GPU), or an artificial intelligence computing unit. The artificial intelligence computing unit may include at least one of a Neural Processing Unit (NPU), a Tensor Processing Unit (TPU), or a Kunlun core. The operator unit may be, for example, a CUDA core in the GPU, a stream processor unit, etc. It should be noted that the specific type of the operator unit will not be limited in embodiments of the present disclosure, as long as the operator unit can perform a data computational task.

According to embodiments of the present disclosure, the storage unit may be an apparatus or component for storing data. For example, the storage unit may be any type of component for caching data, such as an on-chip cache, an off-chip cache, etc. The specific type of the storage unit will not be limited in embodiments of the present disclosure.

In embodiments of the present disclosure, the target model may be an algorithmic model constructed based on a deep learning algorithm. For example, the target model may be constructed based on any type of deep learning algorithm, such as an attention network algorithm, a convolutional neural network algorithm, etc. The target model may include one or more target network layers, and the hyperparameter of the target network layer may refer to a model parameter of the target network layer. For example, the hyperparameter of the target network layer may include a weight parameter (w), a bias parameter (b), etc. The hyperparameter of each network layer in the target model is stored in the storage unit. By inputting any type of to-be-processed data, such as text, an image, an audio, graph data, etc. to be processed into the target model, the operator unit may execute a computational task on the to-be-processed data based on the hyperparameters of one or more target network layers in the target model received from the storage unit, so as to process the to-be-processed data using the target model, thereby obtaining the model output result of the target model. The model output result may include a data processing result for any type of to-be-processed data, such as a text, an image, an audio, graph data, etc. For example, the model output result may be an output text, a rendered image, edited audio data, etc.

According to embodiments of the present disclosure, the computational task may include a plurality of subtasks executed in a preset sequence, and the first computational subtask and the second computational subtask may be two subtasks sequentially executed in the computational task. It should be noted that, among the plurality of subtasks sequentially executed, a preceding subtask may be the first computational subtask, and a subsequent subtask executed in turn adjacent to the preceding subtask may be the second computational subtask.

According to embodiments of the present disclosure, the first feature and the second feature may be hidden features output by the target network layer. By using the operator unit to execute the first computational subtask according to the hyperparameter of the target network layer to obtain the first feature, and using the operator unit to execute the second computational subtask in turn in response to reusing the hyperparameter of the target network layer retrieved from the storage unit, a plurality of subtasks in the computational task are executed by circularly reusing the hyperparameter of the target network layer retrieved from the storage unit. In this way, when the storage unit only stores the hyperparameter of the target network layer, data deep processing may be performed on the to-be-processed data input into the target model by cyclically retrieving the hyperparameter and using a computing unit to reuse the same hyperparameter, which avoids a high storage space occupancy of the storage unit caused by executing a plurality of different subtasks through respective hyperparameters of a plurality of different network layers, thereby reducing a storage space occupation of the storage unit. And, simulating a data deep processing process of a large model with massive model parameters is achieved when the storage unit has a small storage hyperparameter scale; and an accuracy of the model output result of the target model determined based on the second feature is close to an accuracy of an output result obtained by processing the to-be-processed data using a large model with a plurality of network layer structures, which avoids a loss of algorithmic performance of the target model, reduces a computational overhead and a storage space occupation of the target model in a process of performing data processing under a condition of reducing a hyperparameter scale of the target model, and reduces a computational performance requirement and a storage space requirement of a computing device on which a model is deployed, thereby improving a convenience and a generalization ability of deployment of the target model in the computing device, and reducing an inference cost and a deployment cost of the target model.

According to embodiments of the present disclosure, the first feature and the second feature may include a text feature, the text feature is determined based on an initial text, and the model output result includes an output text corresponding to the initial text.

According to embodiments of the present disclosure, the initial text may be to-be-processed data input into the target model. The initial text may include any type of text for input, such as a question text, a requirement text, etc. The output text may be a feedback text output by the target model to meet a requirement intention represented by the initial text. For example, the output text may be an answer text corresponding to the question text.

It should be noted that the to-be-processed data for a computational task may be stored in a storage unit associated with the operator unit. A storage space for the to-be-processed data and a storage space for the hyperparameter of the target model may be the same or different, which will not be limited in embodiments of the present disclosure.

According to the method provided by embodiments of the present disclosure, by using the operator unit to cyclically reuse the hyperparameter of the target network layer in the storage unit to sequentially execute a plurality of subtasks so as to process the initial text, the target model may achieve deep semantic understanding of the initial text under a condition of reducing a parameter quantity scale of hyperparameters, thereby achieving a text semantic understanding capability and a task execution control capability of a large language model with massive model parameters for the initial text. In this way, an accuracy of an output text of the target model is close to an accuracy of text output by the large language model, thereby reducing a storage space occupancy of the computing device, reducing a deployment cost of the computing device to deploy the large language model, and enhancing a generalization ability and an adaptability of the target model in different application scenarios.

According to embodiments of the present disclosure, the first feature or the second feature may further include a hidden feature representing other modal data. For example, the first feature or the second feature may be an image feature representing image-modal data, or may be an audio feature representing audio-modal data, etc. The computational task may be a processing task for any modal data, such as an image processing task, an audio processing task, etc.

Alternatively, the first feature or the second feature may further include a multi-modal fusion feature representing fused multi-modal data. For example, the first feature or the second feature may be an image-text fusion feature which fuses image semantics and text semantics. The modal type of the data represented by the first feature or the second feature will not be limited in embodiments of the present disclosure.

According to embodiments of the present disclosure, the storage unit includes an on-chip storage unit, and the hyperparameter of the target network layer, the first feature, and the second feature are stored in the on-chip storage unit.

According to embodiments of the present disclosure, the on-chip storage unit may be provided in the same processor as the operator unit. By storing the hyperparameter of the target network layer, the first feature, and the second feature in the on-chip storage unit, the hyperparameter of the target network layer, the first feature, or the second feature may be quickly retrieved, so as to improve an execution efficiency of the operator unit in executing a subtask, thereby enhancing a computing efficiency of the target model. And, by storing only the hyperparameter of the target network model in the on-chip storage unit, a storage space occupancy of off-chip storage units, such as a video memory component, a memory component, etc., may be reduced, thereby improving an overall computing efficiency of the computing device in which the target model is deployed.

In an example, an operator unit of the Graphics Processing Unit (GPU) may be a CUDA core, and the on-chip storage unit may be an L1 cache component or an L2 cache component of the GPU. The CUDA core may sequentially execute a plurality of subtasks of the computational task by cyclically calling the hyperparameter of the same target network layer from the L1 cache component or L2 cache component frequently, so as to improve a computing efficiency of the GPU and reduce an occupancy of computing resources.

In an example, the storage unit may also be an off-chip storage unit. For example, the storage unit may be an off-chip video memory unit of the GPU. When the target model includes a plurality of target network layers, the hyperparameter of the target network layer may be stored in the off-chip video memory unit, so that the operator unit of the GPU may retrieve the hyperparameter of the target network layer from the off-chip video memory unit multiple times when executing the subtasks, thereby facilitating the execution of the subtasks. The first feature or the second feature may be stored in the off-chip storage unit, so that the operator unit may sequentially execute the plurality of subtasks of the computational task.

In an example, the storage unit may also be an on-chip storage unit and an off-chip storage unit. As the hyperparameter of the target network layer is cyclically called by the operator unit to execute the subtasks, the hyperparameter of the target network layer may be stored in the on-chip storage unit, so that the operator unit may quickly and frequently reuse the hyperparameter of the target network layer to execute the plurality of subtasks of the computational task. A network layer feature output by the target network layer obtained by executing the subtask may be stored in the off-chip storage unit, so as to utilize the larger storage space of the off-chip storage unit to accommodate the network layer feature of high dimension. It should be understood that the network layer feature may include the first feature and the second feature.

According to embodiments of the present disclosure, the target network layer includes at least one of an attention layer or a feedforward layer, and the first feature or the second feature includes at least one of an attention feature or a feedforward feature.

According to embodiments of the present disclosure, the target model may be constructed based on an attention network algorithm, and the attention layer may include an attention layer constructed based on an attention mechanism. For example, the attention layer may include a multi-head attention layer constructed based on a Multi-Head Self-Attention (MHA) mechanism. The feedforward layer may be a network layer constructed based on a Feed-Forward Neural Network (FFNN). It should be understood that the attention feature may be a feature output by the attention layer.

In an example, the target network layer may be an attention layer. In this way, the operator unit may be used to perform multi-level deep attention fusion on the to-be-processed data by reusing the hyperparameter of the attention layer, which enables the operator unit to sequentially execute the plurality of subtasks and obtain final attention features that fully learn semantic attribute features of the to-be-processed data, such as an image semantic feature, a text semantic feature, etc., thereby improving an output accuracy of a model output result and enhancing a degree of matching between the model output result and a requirement intention of the target object.

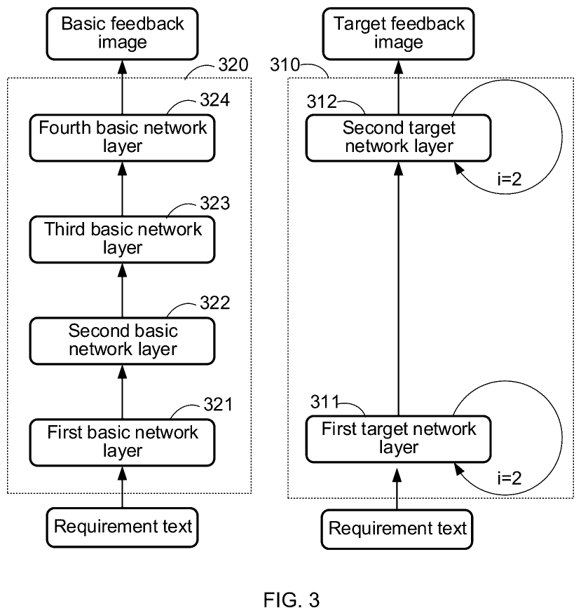

FIG. 3 schematically shows a schematic diagram of a target model according to embodiments of the present disclosure.

As shown in FIG. 3, a target model 310 may include a first target network layer 311 and a second target network layer 312. The first target network layer 311 and the second target network layer 312 may be a multi-head attention layer and a feedforward layer, respectively. An initial text feature of a requirement text is stored in the storage unit, and the operator unit is used to process the initial text feature of the requirement text according to the hyperparameter of the first target network layer 311, so as to execute a first computational subtask in a first computational task, thereby obtaining a first text feature output by the first target network layer 311. When the preset number i of subtasks sequentially executed in the first computational task is two, that is, i=2, in response to reusing the hyperparameter of the first target network layer 311 in the storage unit, the operator unit may be used to retrieve the first text feature and the hyperparameter of the first target network layer 311 from the storage unit, so as to execute a second computational subtask, thereby obtaining a second text feature output by the first target network layer 311.

For comparison, a trained basic large model 320 may include a first basic network layer 321, a second basic network layer 322, a third basic network layer 323, and a fourth basic network layer 324. In the case that the operator unit reuses the hyperparameter of the first target network layer 311 to sequentially execute two subtasks in the first computational task, a feature data deep processing process of the initial text feature of the requirement text by the first basic network layer 321 and the second basic network layer 322 in the basic large model 320 is simulated, thereby avoiding a defect of reduced computational performance caused by directly removing a basic network layer of the basic large model 320 to determine the target model, reducing a storage space occupied by the hyperparameter stored in the storage unit, and reducing an occupancy of computing resources of the computing device.

As shown in FIG. 3, the second text feature output by the first target network layer 311 is stored in the storage unit, the operator unit processes the second text feature according to a hyperparameter of the second target network layer 312, so as to execute a first computational subtask in the second computational task, thereby obtaining a first text feature output by the second target network layer 312. When the preset number of subtasks sequentially executed in the second computational task is two, that is i=2, in response to reusing the hyperparameter of the second target network layer 312 in the storage unit, the operator unit retrieves the first text feature output by the second target network layer 312 and the hyperparameter of the second target network layer 312 from the storage unit, so as to execute a second computational subtask in the second computational task, thereby obtaining a second text feature output by the second target network layer 312. By using the operator unit to process the second text feature output by the second target network layer 312 based on an activation function, a target feedback image is obtained. The target feedback image may be an image satisfying a requirement intention represented by the requirement text.

In the case that the operator unit reuses the hyperparameter of the second target network layer 312 in the storage unit to sequentially execute two subtasks in the second computational task, a feature data deep processing process by the third basic network layer 323 and the fourth basic network layer 324 in the basic large model 320 is simulated, which avoids a defect of reduced computational performance caused by directly removing the basic network layer of the basic large model 320 to determine the target model, and generates a target feedback image with an image quality similar to that of a basic feedback image, thereby reducing a storage space occupied by the hyperparameter of the target model in the storage unit, and improving a deployment efficiency and an inference efficiency of the target model in the computing device.

According to embodiments of the present disclosure, the computational task includes a preset number of subtasks executed sequentially. The operator unit may use the hyperparameter of the target network layer the preset number of times to execute the preset number of subtasks, thereby achieving a data deep processing process of the large model by reusing the hyperparameter of the target network layer the preset number of times, so as to improve an accuracy of the model output result.

In an example, the preset number is determined based on a configuration operation of the target object. The target object may set the preset number of times the hyperparameter of at least one target network layer in the target model is reused through the configuration operation, so that the operator unit may perform a dynamic configuration on a deep processing requirement for the to-be-processed data according to requirements of the target object, so as to obtain a model output result satisfying an actual requirement intention of the target object. In this way, the target model may adapt to various output accuracy requirements and output latency requirements of the target object. And, the number of times the hyperparameter of the same target network layer in the storage unit is reused may be flexibly set, thereby improving a utilization of a storage space of the storage unit, reducing an occupation of communication resources caused by transmitting hyperparameters of different network layers to the computing unit multiple times, reducing an occupation of a storage space caused by writing hyperparameters of different network layers into the storage unit multiple times, and enhancing a flexibility and a generalization ability of a deployment and inference process of the target model.

According to embodiments of the present disclosure, the preset number is determined based on requirement information, and the requirement information includes at least one of latency requirement information or accuracy requirement information.

According to embodiments of the present disclosure, the latency requirement information represents an output latency requirement for the target model to output the model output result. The output latency requirement may represent a latency duration of the target object for the target model to process the to-be-processed data and output the model output result, and the latency duration may be proportional to the preset number. When the latency duration corresponding to the output latency requirement is longer, the preset number may be set to be greater, so as to facilitate performing deep data processing on the to-be-processed data based on the greater preset number, thereby improving an accuracy of the model output result of the target model. When the latency duration corresponding to the output latency requirement is shorter, the preset number may be set to be smaller, so as to control the number of times the subtasks of the computational task are executed to be smaller. In this way, the target model may perform data processing on the to-be-processed data more quickly, so as to increase a speed at which the target model obtains the model output result, reduce a latency of the target model in an inference process, and satisfy an actual requirement for low-latency scenarios.

According to embodiments of the present disclosure, the accuracy requirement information represents an output accuracy requirement for the model output result. The output accuracy requirement may represent a quality of the model output result of the target model. The output accuracy requirement may refer to a degree of matching between the model output result of the target model and a real requirement objective of the target object.

For example, when the to-be-processed data processed by the target model is text, the output accuracy requirement may represent text accuracy attributes for output text of the target model, such as accuracy, relevance, fluency, and coherence. The accuracy may indicate whether the output text contains correct information and conforms to factual, logical, and semantic requirements. The relevance is used to evaluate whether the output text is closely related to an input prompt or context. The fluency and the coherence are used to indicate whether the output text is smooth and natural, and logically coherent.

For another example, when the to-be-processed data processed by the target model is an image, the output accuracy requirement may represent image accuracy attributes for an output image of the target model, such as class accuracy, detection accuracy, or generation quality. The class accuracy indicates a proportion of correctly identifying a category to which an image belongs by the target model. The detection accuracy indicates an accuracy of a recognition result of accurately identifying a position, a category, a size, etc., of an object in the image by the target model. The generation quality indicates a visual quality of the output image of the target model and a degree of matching with a requirement intention of the target object.

It should be noted that the model output result of the target model and the to-be-processed data processed by the target model may be any modal data, which will not be limited in embodiments of the present disclosure.

According to embodiments of the present disclosure, the latency requirement information and the accuracy requirement information may be determined based on the configuration operation of the target object. For example, the configuration operation may be performed by the target object through an interactive interface, so as to achieve the setting of the latency requirement information and the accuracy requirement information, which may facilitate a flexible control of an inference process of the target model, and a flexible control of an inference accuracy and inference latency of the target model, thereby satisfying actual requirements in diverse artificial intelligence application scenarios.

According to embodiments of the present disclosure, the target model is determined by: determining, using the operator unit, a similarity index of at least one specified basic network layer among basic network layers in a trained basic large model; and determining, from the trained basic large model, N basic network layers satisfying a similarity condition based on the similarity index; and determining the target model based on M basic network layers satisfying the similarity condition.

According to embodiments of the present disclosure, the trained basic large model may be a generative large model for performing a specific function. The trained basic large model may include a plurality of basic network layers. A further basic network layer may refer to a basic network layer among the basic network layers in the trained basic large model other than the specified basic network layer. The similarity index represents a hyperparameter similarity between the specified basic network layer and the further basic network layer among the basic network layers in the trained basic large model. The similarity index between the specified basic network layer and the further basic network layer may be determined by calculating a similarity between a hyperparameter of the specified basic network layer and a hyperparameter of the further basic network layer.

According to embodiments of the present disclosure, N>M≥1, and N and M are integers. For example, the target model may be constructed by selecting a basic network layer from ten basic network layers satisfying the similarity condition as the target network layer.

In an example, the determining the target model based on M basic network layers satisfying the similarity condition may include removing N-M basic network layers from the N basic network layers satisfying the similarity condition in the basic large model, thereby retaining the M basic network layers satisfying the similarity condition, so as to obtain the target model.

According to embodiments of the present disclosure, the similarity condition may refer to that a similarity of hyperparameters of the N basic network layers is greater than or equal to a preset similarity threshold. The N basic network layers satisfying the similarity condition may have a similar or comparable task execution capability. For example, they may have a similar capability in learning feature information, such as a text feature, an image feature, etc. Therefore, by determining the M basic network layers satisfying the similarity condition from the N basic network layers satisfying the similarity condition as the target network layers to construct the target model, the target model may have specific functions of the trained basic large model, such as text response, image generation, etc., under a condition of reducing a parameter quantity scale of hyperparameters. And, by setting the preset number of subtasks in the computational task, the hyperparameter of the target network layer may be reused to execute the preset number of subtasks. In this way, the operator unit executes the subtasks by reusing the hyperparameter of the same target network layer multiple times, so that an accuracy of the model output result of the target model is close to an accuracy of a basic output result of the trained basic large model, thereby reducing a deployment cost and an inference cost of the target model, improving an inference efficiency and accuracy of the target model deployed in the computing device, and satisfying actual intelligent model output requirements in diverse scenarios.

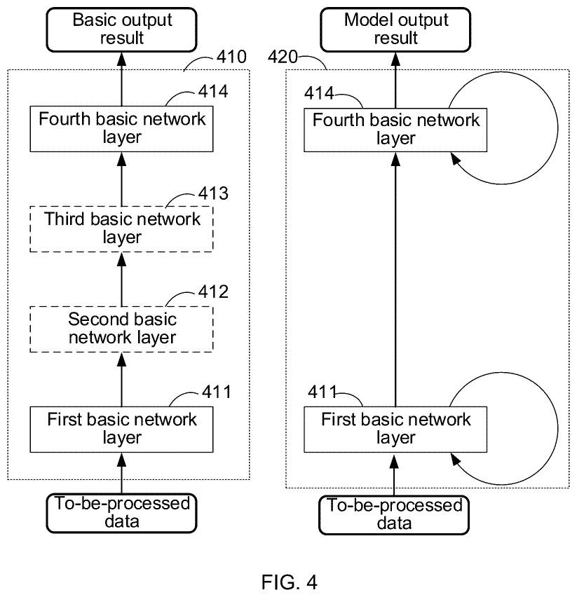

FIG. 4 schematically shows a schematic diagram of determining a target model according to embodiments of the present disclosure.

As shown in FIG. 4, a trained basic large model 410 includes a first basic network layer 411, a second basic network layer 412, a third basic network layer 413, and a fourth basic network layer 414. By calculating a similarity between a hyperparameter of the second basic network layer 412 and a hyperparameter of a further basic network layer among the basic network layers in the trained basic large model 410, a similarity index of the second basic network layer 412 may be obtained. The similarity index of the second basic network layer 412 may indicate that a similarity condition between the first basic network layer 411 and the second basic network layer 412 is satisfied. By calculating a similarity between a hyperparameter of the third basic network layer 413 and a hyperparameter of a further basic network layer among the basic network layers in the trained basic large model 410, a similarity index of the third basic network layer 413 may be obtained. The similarity index of the third basic network layer 413 may indicate that the similarity condition between the third basic network layer 413 and the fourth basic network layer 414 is satisfied. A target model 420 may be obtained by removing the second basic network layer 412 and the third basic network layer 413 from the trained basic large model 410. The operator unit is used to execute two subtasks sequentially executed in the first computational task by reusing a hyperparameter of the first basic network layer 411, a deep data processing process of the first basic network layer 411 and the second basic network layer 412 of the trained basic large model 410 is simulated. The operator unit is used to execute two subtasks sequentially executed in the second computational task by reusing a hyperparameter of the fourth basic network layer 414, a deep data processing process of the third basic network layer 413 and the fourth basic network layer 414 of the trained basic large model 410 is simulated. In this way, a generation accuracy of a model output result obtained by the target model 420 in processing the to-be-processed data is close to a generation accuracy of a basic output result obtained by the trained basic large model 410 in processing the to-be-processed data, which ensures that the target model 420 has a generation effect similar to that of the trained basic large model 410 with a large parameter quantity, thereby reducing an occupation of computing resources, and reducing an inference cost and a deployment difficulty of the target model 420. And, by setting the preset number of subtasks sequentially executed in the computational task, the target model 420 performs a deeper-level data processing process on the to-be-processed data compared with the trained basic large model 410, so as to flexibly adapt to an accuracy requirement and a latency requirement of the target object for model output result, and improve a deployment flexibility and a generalization ability of the target model 420.

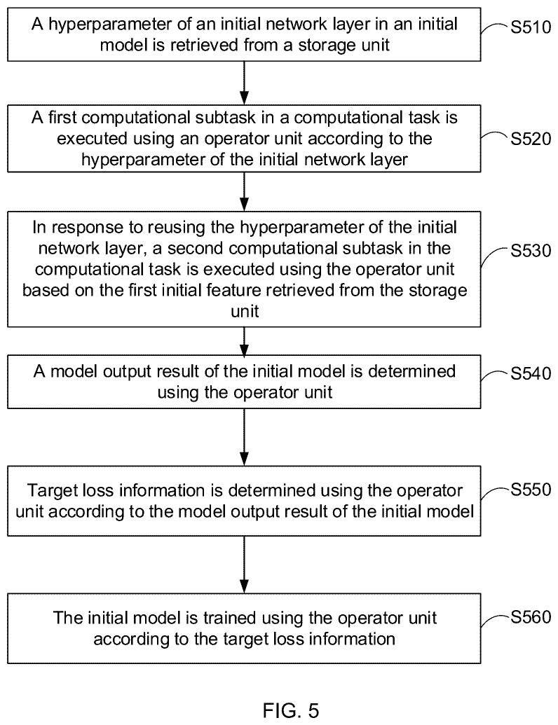

FIG. 5 schematically shows a flowchart of a model training method according to embodiments of the present disclosure.

As shown in FIG. 5, the model training method includes operations S510 to S560.

In the operation S510, a hyperparameter of an initial network layer in an initial model is retrieved from a storage unit.

In the operation S520, a first computational subtask in a computational task is executed using an operator unit according to the hyperparameter of the initial network layer, so as to obtain a first initial feature output by the initial network layer.

In the operation S530, in response to reusing the hyperparameter of the initial network layer, a second computational subtask in the computational task is executed using the operator unit based on the first initial feature retrieved from the storage unit, so as to obtain a second initial feature output by the initial network layer.

In the operation S540, a model output result of the initial model is determined using the operator unit based on the second initial feature retrieved from the storage unit.

In the operation S550, target loss information is determined using the operator unit according to the model output result of the initial model.

In the operation S560, the initial model is trained using the operator unit according to the target loss information, so as to obtain a trained target model.

According to embodiments of the present disclosure, the first computational subtask and the second computational subtask are subtasks sequentially executed in the computational task. The operator unit may sequentially execute the subtasks multiple times under a condition of reusing the hyperparameter of the initial network layer, so as to reduce a storage space occupation of the hyperparameter in the storage unit.

According to embodiments of the present disclosure, the storage unit may be an apparatus or component for storing data. For example, the storage unit may be any type of component for caching data, such as an on-chip cache, an off-chip cache, etc. The specific type of the storage unit will not be limited in embodiments of the present disclosure.

According to embodiments of the present disclosure, the initial model may be an algorithm model constructed based on a deep learning algorithm. For example, the initial model may be constructed based on any type of deep learning algorithm such as an attention network algorithm, a convolutional neural network algorithm, etc. The initial model may include one or more initial network layers, and the hyperparameter of the initial network layer may refer to a model parameter of the initial network layer. For example, the hyperparameter of the initial network layer may be a weight parameter w, a bias parameter b, etc. Any type of to-be-processed data, such as text, an image, an audio, graph data, etc., may be input into the initial model. The operator unit may execute the computational task on the to-be-processed data based on the hyperparameters of one or more initial network layers in the initial model, so that the initial model may process the to-be-processed data to obtain the model output result of the initial model. The model output result may include a data processing result for any type of to-be-processed data, such as text, an image, an audio, graph data, etc. For example, the model output result may be output text, a rendered image, edited audio data, etc.

It should be noted that the technical terms involved in the model training method provided by embodiments of the present disclosure, including but not limited to the first initial feature, the second initial feature, the operator unit, the storage unit, etc., have the same attributes as the technical terms involved in the task execution method provided by embodiments of the present disclosure, including but not limited to the first feature, the second feature, the operator unit, the storage unit, etc., which will not be repeated in embodiments of the present disclosure.

According to embodiments of the present disclosure, the first initial feature and the second initial feature may be hidden features output by the initial network layer. By using the operator unit to execute the first computational subtask according to the hyperparameter of the initial network layer to obtain the first initial feature, and using the operator unit to execute the second computational subtask in turn by reusing the hyperparameter of the initial network layer retrieved from the storage unit, a plurality of subtasks in the computational task may be executed by cyclically reusing the hyperparameter of the initial network layer, where in the computational task, the second computational subtask is executed in order after the first computational subtask. In this way, when the storage unit only stores the hyperparameter of the initial network layer, data deep processing may be performed on to-be-processed sample data input into the initial model by cyclically retrieving the hyperparameter, thereby reducing a storage space occupation of the storage unit. As a result, a data deep processing process of a large model with massive model parameters is simulated when the storage unit has a small storage hyperparameter scale, so that an accuracy of the model output result of the initial model determined based on the second initial feature is close to an accuracy of that of the large model in processing the to-be-processed sample data, thereby avoiding a loss of algorithm performance of the initial model, and reducing a computational overhead and a storage space occupation of the initial model in executing the data processing process under a condition of reducing a hyperparameter scale of the initial model. By using the operator unit to train the initial model based on the target loss information determined according to the model output result of the initial model, a storage space of the storage unit occupied in a model training process is reduced, and the operator unit quickly calls the hyperparameter of the initial model to execute the subtask, thereby reducing a training cost of the computing device for training the initial model and reducing an occupation of computing resources in the model training process.

The target model determined according to the model training method provided by embodiments of the present disclosure may be applied to the task execution method provided by embodiments of the present disclosure. For example, the hyperparameter of the target model determined based on the model training method provided by embodiments of the present disclosure may be stored in the storage unit, and the operator unit may be used to execute the computational task based on the hyperparameter of the target network layer of the target model according to the task execution method provided by embodiments of the present disclosure, so as to process to-be-processed data of any modality and obtain the model output result.

According to embodiments of the present disclosure, the initial model is determined by: determining, using the operator unit, a similarity index of at least one specified basic network layer among basic network layers in a basic large model; determining, from the basic large model, K basic network layers satisfying a similarity condition based on the similarity index; and determining the initial model based on P basic network layers satisfying the similarity condition.

According to embodiments of the present disclosure, the basic large model may include any type of deep learning model with large-scale hyperparameters. For example, the basic large model may include a trained large language model. Alternatively, the basic large model may also be a large model for processing any modal data such as audio data, image data, graph data, etc. The basic large model may include a plurality of basic network layers, and the similarity index represents a hyperparameter similarity between the specified basic network layer and a further basic network layer among the basic network layers in the basic large model. It should be understood that the further basic network layer may include a basic network layer among the basic network layers in the basic large model other than the specified basic network layer. The similarity index between the specified basic network layer and the further basic network layer may be determined by calculating a similarity between a hyperparameter of the specified basic network layer and a hyperparameter of the further basic network layer.

According to embodiments of the present disclosure, K>P≥1, and K and P are integers. For example, the initial model may be constructed by selecting a basic network layer from ten basic network layers satisfying the similarity condition as the initial network layer.

In an example, the determining the initial model based on P basic network layers satisfying the similarity condition may include removing K-P basic network layers from the K basic network layers satisfying the similarity condition in the basic large model, thereby retaining the P basic network layers satisfying the similarity condition, so as to obtain the initial model.

According to embodiments of the present disclosure, the similarity condition may refer to that a similarity of hyperparameters of the K basic network layers is greater than or equal to a preset similarity threshold. The K basic network layers satisfying the similarity condition may have a similar or comparable task execution capability. For example, they may have a similar capability in learning feature information, such as a text feature, an image feature, etc. Therefore, by determining the P basic network layers satisfying the similarity condition from the K basic network layers satisfying the similarity condition as the initial network layers to construct the initial model, the initial model may have specific functions of the basic large model, such as text response, image generation, etc., under a condition of reducing a parameter quantity scale of hyperparameters. And, by setting the preset number of subtasks in the computational task, the hyperparameter of the initial network layer may be reused to execute the preset number of subtasks. In this way, the operator unit may be used to execute the plurality of subtasks by reusing the hyperparameter of the same initial network layer, so that an accuracy of the model output result of the initial model is close to an accuracy of a basic output result of the trained basic large model. Therefore, the initial model may be constructed by determining a smaller number of P basic network layers from the K basic network layers satisfying the similarity condition, a storage space occupied by the hyperparameter of the initial model stored in the storage unit is reduced, and the operator unit may be used to sequentially execute the plurality of subtasks by reusing the hyperparameter of the initial network layer, so as to achieve deep data processing performance of the basic large model. In this way, when the number of hyperparameters is small, the target model trained based on the target loss information may have data processing performance and model output result generation accuracy close to those of the large model, thereby improving a training efficiency and satisfying actual intelligent model output requirements in diverse scenarios.

According to embodiments of the present disclosure, the determining, using the operator unit, a similarity index of at least one specified basic network layer among basic network layers in a basic large model includes: removing at least one specified basic network layer from the basic large model using the operator unit, so as to obtain a processed basic large model; executing, based on preset training data, a basic computational task based on a hyperparameter of an updated basic large model using the operator unit, so as to obtain a basic output result of the processed basic large model; processing the basic output result of the processed basic large model and a label corresponding to the training data using the operator unit, so as to obtain a basic output accuracy of the processed basic large model; and determining the similarity index of the specified basic network layer using the operator unit based on the basic output accuracy of the processed basic large model.

According to embodiments of the present disclosure, the preset training data may be to-be-processed sample data of any modality. For example, the training data may include sample text, a sample image, a sample audio, etc. By using the operator unit to process the training data based on the hyperparameter of the processed basic large model, the basic output result output by the basic large model may be obtained. The basic output result may be a feedback result corresponding to a requirement intention represented by the training data.

In an example, when the training data is to-be-processed sample text, the basic output result of the processed basic large model may be an answer text corresponding to the to-be-processed sample text.

In an example, when the training data is to-be-processed sample text, the basic output result of the processed basic large model may be a generated image corresponding to a requirement intention of the to-be-processed sample text.

In an example, the processing the basic output result of the processed basic large model and a label corresponding to the training data using the operator unit may include processing the basic output result of the processed basic large model and the label based on a loss function, so as to obtain basic loss information. A basic output accuracy may be determined based on difference information represented by the basic loss information.

According to embodiments of the present disclosure, the determining the similarity index of the specified basic network layer using the operator unit based on the basic output accuracy of the processed basic large model may include querying associated similarity index information based on the basic output accuracy.

In an example, the label may be a basic output result obtained by processing the training data using an unprocessed basic large model. The similarity index may refer to an accuracy similarity of the generated result between the basic output result output by the processed basic large model in which the specified basic network layer has been removed and the basic output result of an original basic large model. When the accuracy similarity is higher, the hyperparameter similarity represented by the similarity index is greater, which may be understood as the impact on an accuracy of the basic output result of the basic large model in which the specified basic network layer has been removed being very small. When the accuracy similarity is lower, the hyperparameter similarity represented by the similarity index is smaller, which may be understood as the impact on the accuracy of the basic output result of the basic large model in which the specified basic network layer has been removed being very great. The basic output accuracy may be proportional to the hyperparameter similarity represented by the similarity index. In this way, the K basic network layers satisfying the similarity condition may be determined by determining the similarity index of the specified basic network layer, and the initial model may be constructed by determining a small number of P basic network layers satisfying the similarity condition from the K basic network layers, so that the initial model may output a result with an accuracy close to that of the basic output result of the basic large model under a condition that the operator unit reuses the hyperparameter of the initial network layer. This may reduce a construction complexity of the initial model, reduce a difficulty of knowledge transfer from the basic large model to the initial model, and improve a training efficiency of the initial model.

According to embodiments of the present disclosure, the determining target loss information using the operator unit according to the model output result of the initial model may include: processing, using the operator unit, the model output result of the initial model and a basic output result of a basic large model based on a knowledge distillation mechanism, so as to obtain output loss information; processing at least one initial feature and a basic task computational result using the operator unit, so as to obtain intermediate loss information; and fusing the output loss information and the intermediate loss information using the operator unit, so as to obtain the target loss information.

According to embodiments of the present disclosure, the basic task computational result is determined by executing a basic computational task using the operator unit based on a hyperparameter of a basic network layer in the basic large model, and the basic output result is determined based on the basic task computational result. The basic task computational result may be a hidden feature output by the basic network layer, and the basic output result may be a generated result output by the basic large model.

For example, the basic output result and the model output result of the initial model may be obtained by the basic large model and the initial model in processing the same batch of training data, respectively.

According to embodiments of the present disclosure, the processing, using the operator unit, the model output result of the initial model and a basic output result of a basic large model based on a knowledge distillation mechanism may include processing, using the operator unit, the basic output result and the model output result of the initial model based on a loss function by taking the basic output result as a pseudo-label. The obtained output loss information may indicate a generation accuracy difference between the basic output result and the model output result of the initial model.

According to embodiments of the present disclosure, the initial feature includes at least one of the first initial feature or the second initial feature. The initial feature may indicate a hidden feature of the initial model obtained by the operator unit after executing the subtasks based on the hyperparameter of the initial network layer. The processing at least one initial feature and a basic task computational result using the operator unit may include processing, by taking a basic computational result output by the basic network layer as a pseudo-label, the basic computational result and the corresponding initial feature using the operator unit based on the loss function. The obtained intermediate loss information may indicate a feature difference between a hidden feature of the initial network layer obtained by the initial network layer in executing each subtask and a hidden feature output by a corresponding basic network layer corresponding to the subtask in the basic large model. Therefore, based on the intermediate loss information, a difference between an initial feature obtained by the operator unit in executing a subtask based on the hyperparameter of the initial network layer and a basic computational result obtained by the operator unit in executing the basic computational task based on the hyperparameter of the basic network layer may be indicated. In this way, by adjusting the hyperparameter of the initial model in a training process based on the target loss information obtained by fusing the intermediate loss information and the output loss information, the operator unit may use a hyperparameter of a trained target network layer to simulate a data processing capability and a semantic understanding capability of each basic network layer by sequentially executing the subtasks, so that the target model may have a data processing capability and a model output result accuracy close to those of algorithm performance of the large model with a greater parameter scale based on a smaller hyperparameter scale stored in the storage unit, thereby improving an inference efficiency of the target model in an inference stage and reducing a deployment cost of the target model.

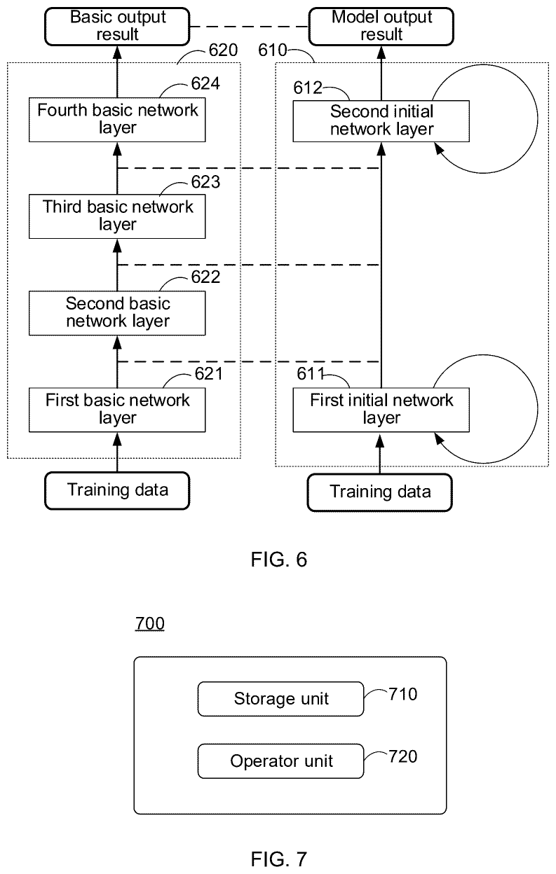

FIG. 6 schematically shows a schematic diagram of a model training method according to embodiments of the present disclosure.

As shown in FIG. 6, an initial model 610 may include a first initial network layer 611 and a second initial network layer 612, and the basic large model 620 includes a first basic network layer 621, a second basic network layer 622, a third basic network layer 623, and a fourth basic network layer 624. The basic large model 620 is used as a teacher model, and the initial model 610 is used as a student model. The operator unit is used to process training data based on a hyperparameter of the first basic network layer 621, so as to obtain a first basic task computational result output by the first basic network layer 621. The operator unit is used to process the first basic task computational result based on a hyperparameter of the second basic network layer 622, so as to obtain a second basic task computational result output by the second basic network layer 622. The operator unit is used to process the second basic task computational result based on a hyperparameter of the third basic network layer 623, so as to obtain a third basic task computational result output by the third basic network layer 623. The operator unit is used to process the third basic task computational result based on a hyperparameter of the fourth basic network layer 624, so as to obtain a basic output result output by the fourth basic network layer 624.

The operator unit is used to execute the first computational subtask in the first computational task based on a hyperparameter of the first initial network layer 611 and the training data, so as to obtain a first initial feature output by the first initial network layer 611. In response to reusing the hyperparameter of the first initial network layer 611, the operator unit is used to execute the second computational subtask in the first computational task based on the hyperparameter of the first initial network layer 611 and the first initial feature output by the first initial network layer 611, so as to obtain a second initial feature output by the first initial network layer 611. The operator unit is used to execute the first computational subtask in the second computational task based on a hyperparameter of the second initial network layer 612 and the second initial feature output by the first initial network layer 611, so as to obtain a first initial feature output by the second initial network layer 612. In response to reusing the hyperparameter of the second initial network layer 612, the operator unit is used to execute the second computational subtask in the second computational task based on the hyperparameter of the second initial network layer 612 and the first initial feature output by the second initial network layer 612, so as to obtain a model output result output by the first initial network layer 611.

The operator unit is used to process the first initial feature output by the first initial network layer 611 and the first basic task computational result output by the first basic network layer 621 based on the loss function, so as to obtain first intermediate loss information. The operator unit is used to process the second initial feature output by the first initial network layer 611 and the second basic task computational result output by the second basic network layer 622 based on the loss function, so as to obtain second intermediate loss information. The operator unit is used to process the first initial feature output by the second initial network layer 612 and the third basic task computational result output by the third basic network layer 623 based on the loss function, so as to obtain third intermediate loss information. The operator unit is used to process the model output result output by the second initial network layer 612 and the basic output result output by the fourth basic network layer 624 based on the loss function, so as to obtain the output loss information.

The operator unit is used to perform a weighted average of the first intermediate loss information, the second intermediate loss information, the third intermediate loss information, and the output loss information, so as to obtain the target loss information. A hyperparameter of the initial model 610 is adjusted based on the target loss information until the target loss information converges or a preset number of adjustment rounds is reached, so as to obtain a trained target model.

According to embodiments of the present disclosure, by fusing the output loss information and the intermediate loss information based on the knowledge distillation mechanism, the target loss may represent a difference in algorithm performance between each network layer of the initial model and the basic network layer. In this way, a parameter adjustment may be performed on the initial model based on the target loss information, so as to transfer knowledge of the basic large model to the target model with a smaller parameter scale, which may help the target model learn quickly and avoid a loss of algorithm performance caused by removing hyperparameters of some network layers in the basic large model, thereby improving a training effect.

In an example, the loss function may be a Mean Squared Error (MSE) function.

In an example, the preset number of subtasks sequentially executed in each computational task in the model training method may be determined based on a configuration operation, so that the trained target model may adapt to model performance corresponding to application scenarios of the target object.

In an example, the preset number of subtasks sequentially executed in each computational task in the model training method may be determined based on a random strategy. For example, in each training operation round, the preset number of subtasks sequentially executed in each computational task is a random number determined based on the random strategy. In this way, the initial network layer may randomly adapt to a degree of reuse of the hyperparameter of the initial network layer in each training operation round, so that the trained target model may output a model output result with a high accuracy in application scenarios with different output latency requirements, thereby improving a generalization ability of the target model.

FIG. 7 schematically shows a block diagram of a task execution apparatus according to embodiments of the present disclosure.

As shown in FIG. 7, a task execution apparatus 700 includes: a storage unit 710 and an operator unit 720.

The operator unit 720 is configured to: retrieve, from the storage unit, a hyperparameter of a target network layer in a target model; execute a first computational subtask in a computational task according to the hyperparameter of the target network layer, so as to obtain a first feature output by the target network layer; execute, in response to reusing the hyperparameter of the target network layer, a second computational subtask in the computational task based on the first feature retrieved from the storage unit, so as to obtain a second feature output by the target network layer, where the first computational subtask and the second computational subtask are subtasks sequentially executed in the computational task; and determine a model output result of the target model based on the second feature retrieved from the storage unit.

According to embodiments of the present disclosure, the storage unit includes an on-chip storage unit, and the hyperparameter of the target network layer, the first feature, and the second feature are stored in the on-chip storage unit.

According to embodiments of the present disclosure, the computational task includes a preset number of subtasks executed sequentially, the preset number is determined based on requirement information, and the requirement information includes at least one of latency requirement information representing an output latency requirement for the target model to output the model output result or accuracy requirement information representing an output accuracy requirement for the model output result.

According to embodiments of the present disclosure, the operator unit is further configured to determine the target model by: determining, using the operator unit, a similarity index of at least one specified basic network layer among basic network layers in a trained basic large model, where the similarity index represents a hyperparameter similarity between the specified basic network layer and a further basic network layer among the basic network layers in the trained basic large model; and determining, from the trained basic large model, N basic network layers satisfying a similarity condition based on the similarity index; and determining the target model based on M basic network layers satisfying the similarity condition, where N>M≥1, and N and M are integers.

According to embodiments of the present disclosure, the target network layer includes at least one of an attention layer or a feedforward layer, and the first feature or the second feature includes at least one of an attention feature or a feedforward feature.

According to embodiments of the present disclosure, the first feature and the second feature include a text feature, the text feature is determined according to an initial text, and the model output result includes an output text corresponding to the initial text.

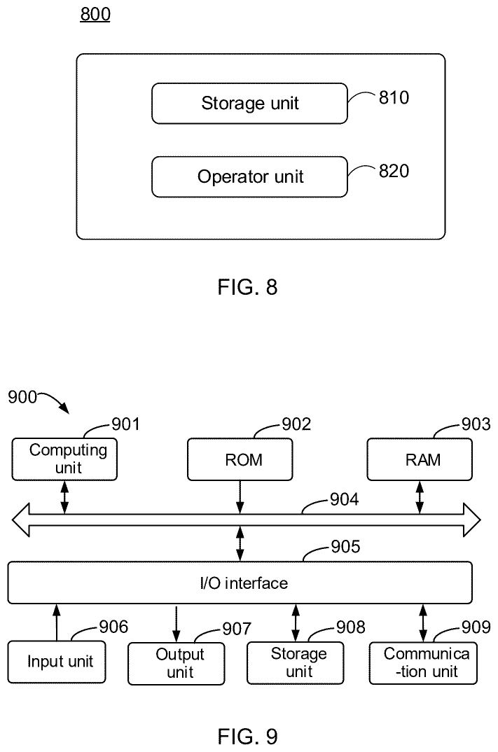

FIG. 8 schematically shows a block diagram of a model training apparatus according to embodiments of the present disclosure.

As shown in FIG. 8, a model training apparatus 800 includes: a storage unit 810 and an operator unit 820.

The operator unit 820 is configured to: retrieve, from the storage unit, a hyperparameter of an initial network layer in an initial model; execute a first computational subtask in a computational task according to the hyperparameter of the initial network layer, so as to obtain a first initial feature output by the initial network layer; execute, in response to reusing the hyperparameter of the initial network layer, a second computational subtask in the computational task based on the first initial feature retrieved from the storage unit, so as to obtain a second initial feature output by the initial network layer, where the first computational subtask and the second computational subtask are subtasks sequentially executed in the computational task; determine a model output result of the initial model based on the second initial feature retrieved from the storage unit; determine target loss information according to the model output result of the initial model; and train the initial model according to the target loss information, so as to obtain a trained target model

According to embodiments of the present disclosure, the operator unit is further configured to determine the initial model by: determining, using the operator unit, a similarity index of at least one specified basic network layer among basic network layers in a basic large model, where the similarity index represents a hyperparameter similarity between the specified basic network layer among the basic network layers and a further basic network layer among the basic network layers in the basic large model; determining, from the basic large model, K basic network layers satisfying a similarity condition based on the similarity index; and determining the initial model based on P basic network layers satisfying the similarity condition, where K>P≥1, and K and P are integers.

According to embodiments of the present disclosure, the operator unit is further configured to determine a similarity index of at least one specified basic network layer among basic network layers in a basic large model by: removing the at least one specified basic network layer from the basic large model, so as to obtain a processed basic large model; executing, based on preset training data, a basic computational task based on a hyperparameter of an updated basic large model, so as to obtain a basic output result of the processed basic large model; processing the basic output result of the processed basic large model and a label corresponding to the training data, so as to obtain a basic output accuracy of the processed basic large model; and determining the similarity index of the specified basic network layer based on the basic output accuracy of the processed basic large model.

According to embodiments of the present disclosure, the operator unit is further configured to determine target loss information according to the model output result of the initial model by: processing the model output result of the initial model and a basic output result of a basic large model based on a knowledge distillation mechanism, so as to obtain output loss information; processing at least one initial feature and a basic task computational result, so as to obtain intermediate loss information, where the basic task computational result is determined by using the operator unit to execute a basic computational task based on a hyperparameter of a basic network layer in the basic large model, the basic output result is determined based on the basic task computational result, and the initial feature includes at least one of the first initial feature or the second initial feature; and fusing the output loss information and the intermediate loss information, so as to obtain the target loss information.

According to embodiments of the present disclosure, the present disclosure further provides an electronic device, a readable storage medium and a computer program product.

According to embodiments of the present disclosure, an electronic device is provided, including: at least one processor; and a memory communicatively connected to the at least one processor; where the memory stores instructions executable by the at least one processor, and the instructions, when executed by the at least one processor, are used to cause the at least one processor to implement the task execution method or the model training method.

According to an embodiment of the present disclosure, a non-transitory computer-readable storage medium having computer instructions stored therein is provided, where computer instructions are used to cause a computer system to implement the task execution method or the model training method

According to embodiments of the present disclosure, a computer program product containing a computer program is provided, where the computer program, when executed by a processor, is used to cause the processor to implement the task execution method or the model training method.

FIG. 9 shows a schematic block diagram of an exemplary electronic device 900 that may be used to implement a task execution method or a model training method according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 9, the electronic device 900 includes a computing unit 901 which may perform various appropriate actions and processes according to a computer program stored in a retrieve only memory (ROM) 902 or a computer program loaded from a storage unit 908 into a random access memory (RAM) 903. In the RAM 1903, various programs and data necessary for an operation of the electronic device 900 may also be stored. The computing unit 901, the ROM 902 and the RAM 903 are connected to each other through a bus 904. An input/output (I/O) interface 905 is also connected to the bus 904.

A plurality of components in the electronic device 900 are connected to the I/O interface 905, including: an input unit 906, such as a keyboard, or a mouse; an output unit 907, such as displays or speakers of various types; a storage unit 908, such as a disk, or an optical disc; and a communication unit 909, such as a network card, a modem, or a wireless communication transceiver. The communication unit 909 allows the electronic device 900 to exchange information/data with other devices through a computer network such as Internet and/or various telecommunication networks.

The computing unit 901 may be various general-purpose and/or dedicated processing assemblies having processing and computing capabilities. Some examples of the computing units 901 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 901 executes various methods and steps described above, such as the task execution method or the model training method. For example, in some embodiments, the task execution method or the model training method may be implemented as a computer software program which is tangibly embodied in a machine-readable medium, such as the storage unit 908. In some embodiments, the computer program may be partially or entirely loaded and/or installed in the electronic device 900 via the ROM 902 and/or the communication unit 909. The computer program, when loaded in the RAM 903 and executed by the computing unit 901, may execute one or more steps in the task execution method or the model training method described above. Alternatively, in other embodiments, the computing unit 901 may be configured to perform the task execution method or the model training method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, so that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a retrieve only memory (ROM), an erasable programmable retrieve only memory (EPROM or a flash memory), an optical fiber, a compact disk retrieve only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or removed in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A task execution method, comprising:
retrieving, from a storage unit, a hyperparameter of a target network layer in a target model;
executing, using an operator unit, a first computational subtask in a computational task according to the hyperparameter of the target network layer, so as to obtain a first feature output by the target network layer;
executing, in response to reusing the hyperparameter of the target network layer, a second computational subtask in the computational task using the operator unit based on the first feature retrieved from the storage unit, so as to obtain a second feature output by the target network layer, wherein the first computational subtask and the second computational subtask are subtasks sequentially executed in the computational task; and
determining a model output result of the target model using the operator unit based on the second feature retrieved from the storage unit.

2. The method according to claim 1, wherein the storage unit comprises an on-chip storage unit, and the hyperparameter of the target network layer, the first feature, and the second feature are stored in the on-chip storage unit.

3. The method according to claim 1, wherein the computational task comprises a preset number of subtasks executed sequentially, the preset number is determined based on requirement information, and the requirement information comprises at least one of latency requirement information representing an output latency requirement for the target model to output the model output result or accuracy requirement information representing an output accuracy requirement for the model output result.

4. The method according to claim 2, wherein the computational task comprises a preset number of subtasks executed sequentially, the preset number is determined based on requirement information, and the requirement information comprises at least one of latency requirement information representing an output latency requirement for the target model to output the model output result or accuracy requirement information representing an output accuracy requirement for the model output result.

5. The method according to claim 1, wherein the target model is determined by:
determining, using the operator unit, a similarity index of at least one specified basic network layer among basic network layers in a trained basic large model, wherein the similarity index represents a hyperparameter similarity between the specified basic network layer and a further basic network layer among the basic network layers in the trained basic large model; and
determining, from the trained basic large model, N basic network layers satisfying a similarity condition based on the similarity index; and
determining the target model based on M basic network layers satisfying the similarity condition, wherein N>M≥1, and N and M are integers.

6. The method according to claim 1, wherein the target network layer comprises at least one of an attention layer or a feedforward layer, and the first feature or the second feature comprises at least one of an attention feature or a feedforward feature.

7. The method according to claim 1, wherein the first feature and the second feature comprise a text feature, the text feature is determined according to an initial text, and the model output result comprises an output text corresponding to the initial text.

8. A model training method, comprising:
retrieving, from a storage unit, a hyperparameter of an initial network layer in an initial model;
executing, using an operator unit, a first computational subtask in a computational task according to the hyperparameter of the initial network layer, so as to obtain a first initial feature output by the initial network layer;
executing, in response to reusing the hyperparameter of the initial network layer, a second computational subtask in the computational task using the operator unit based on the first initial feature retrieved from the storage unit, so as to obtain a second initial feature output by the initial network layer, wherein the first computational subtask and the second computational subtask are subtasks sequentially executed in the computational task;
determining a model output result of the initial model using the operator unit based on the second initial feature retrieved from the storage unit;
determining target loss information using the operator unit according to the model output result of the initial model; and
training the initial model using the operator unit according to the target loss information, so as to obtain a trained target model.

9. The method according to claim 8, wherein the initial model is determined by:
determining, using the operator unit, a similarity index of at least one specified basic network layer among basic network layers in a basic large model, wherein the similarity index represents a hyperparameter similarity between the specified basic network layer among the basic network layers and a further basic network layer among the basic network layers in the basic large model;
determining, from the basic large model, K basic network layers satisfying a similarity condition based on the similarity index; and
determining the initial model based on P basic network layers satisfying the similarity condition, wherein K>P≥1, and K and P are integers.

10. The method according to claim 9, wherein the determining, using the operator unit, a similarity index of at least one specified basic network layer among basic network layers in a basic large model comprises:
removing the at least one specified basic network layer from the basic large model using the operator unit, so as to obtain a processed basic large model;
executing, based on preset training data, a basic computational task based on a hyperparameter of an updated basic large model using the operator unit, so as to obtain a basic output result of the processed basic large model;
processing the basic output result of the processed basic large model and a label corresponding to the training data using the operator unit, so as to obtain a basic output accuracy of the processed basic large model; and
determining the similarity index of the specified basic network layer using the operator unit based on the basic output accuracy of the processed basic large model.

11. The method according to claim 8, wherein the determining target loss information using the operator unit according to the model output result of the initial model comprises:
processing, using the operator unit, the model output result of the initial model and a basic output result of a basic large model based on a knowledge distillation mechanism, so as to obtain output loss information;
processing at least one initial feature and a basic task computational result using the operator unit, so as to obtain intermediate loss information, wherein the basic task computational result is determined by using the operator unit to execute a basic computational task based on a hyperparameter of a basic network layer in the basic large model, the basic output result is determined based on the basic task computational result, and the initial feature comprises at least one of the first initial feature or the second initial feature; and
fusing the output loss information and the intermediate loss information using the operator unit, so as to obtain the target loss information.

12. An electronic device, comprising:
at least one processor; and
a memory communicatively connected to the at least one processor; wherein
the memory stores instructions executable by the at least one processor, and the instructions, when executed by the at least one processor, are configured to cause the at least one processor to at least:
retrieve, from a storage unit, a hyperparameter of a target network layer in a target model;
execute, using an operator unit, a first computational subtask in a computational task according to the hyperparameter of the target network layer, so as to obtain a first feature output by the target network layer;
execute, in response to reusing the hyperparameter of the target network layer, a second computational subtask in the computational task using the operator unit based on the first feature retrieved from the storage unit, so as to obtain a second feature output by the target network layer, wherein the first computational subtask and the second computational subtask are subtasks sequentially executed in the computational task; and
determine a model output result of the target model using the operator unit based on the second feature retrieved from the storage unit.

13. The electronic device according to claim 12, wherein the storage unit comprises an on-chip storage unit, and the hyperparameter of the target network layer, the first feature, and the second feature are stored in the on-chip storage unit.

14. The electronic device according to claim 12, wherein the computational task comprises a preset number of subtasks executed sequentially, the preset number is determined based on requirement information, and the requirement information comprises at least one of latency requirement information representing an output latency requirement for the target model to output the model output result or accuracy requirement information representing an output accuracy requirement for the model output result.

15. The electronic device according to claim 12, wherein the target model is determined by:
determining, using the operator unit, a similarity index of at least one specified basic network layer among basic network layers in a trained basic large model, wherein the similarity index represents a hyperparameter similarity between the specified basic network layer and a further basic network layer among the basic network layers in the trained basic large model; and
determining, from the trained basic large model, N basic network layers satisfying a similarity condition based on the similarity index; and
determining the target model based on M basic network layers satisfying the similarity condition, wherein N>M≥1, and N and M are integers.

16. The electronic device according to claim 12, wherein the target network layer comprises at least one of an attention layer or a feedforward layer, and the first feature or the second feature comprises at least one of an attention feature or a feedforward feature.

17. The electronic device according to claim 12, wherein the first feature and the second feature comprise a text feature, the text feature is determined according to an initial text, and the model output result comprises an output text corresponding to the initial text.

18. An electronic device, comprising:
at least one processor; and
a memory communicatively connected to the at least one processor; wherein
the memory stores instructions executable by the at least one processor, and the instructions, when executed by the at least one processor, are configured to cause the at least one processor to implement the method according to claim 8.

19. A non-transitory computer-readable storage medium having computer instructions stored therein, wherein the computer instructions are configured to cause a computer to implement the method according to claim 1.

20. A non-transitory computer-readable storage medium having computer instructions stored therein, wherein the computer instructions are configured to cause a computer to implement the method according to claim 8.
